(19) United States
(12) Patent Application Publication
(10) Pub. No.: US 2008/0276562 A1
(43) Pub. Date: Nov. 13, 2008

(54) ENGINEERED BRICK

(76) Inventor: Bart Stuchell, Alliance, OH (US)

Correspondence Address: BART STUCHELL, 11773 AEBI AVENUE, ALLIANCE, OH, 44601, US

(21) Appl. No.: 12/119,004

(22) Filed: May 12, 2008

Related U.S. Application Data
(60) Provisional application No. 60/928,459, filed on May 10, 2007.

(51) Int. Cl. E04B 1/14; B29C 70/64; B29L 9/00

(52) U.S. Cl. 52/596; 264/112

(57) ABSTRACT

An engineered brick having a plastic shell having a shape that resembles a conventional brick; and an aggregate layer embedded into the surface of the plastic shell.

### CROSS-REFERENCE TO RELATED APPLICATIONS

This application claims priority to U.S. Ser. No. 60/928,459 titled Light-Weight Brick and Method of Manufacture, filed May 10, 2007. All the subject matter disclosed by U.S. Ser. No. 60/928,459 is hereby incorporated by reference into this application.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

Embodiments are generally directed to an engineered brick and related manufacturing methods.

2. Description of Related Art

Brick masonry can generally be understood as construction in which uniform units, i.e., bricks, are laid in courses with mortar joints to form walls. Conventional bricks are often kiln baked from various clay and shale mixtures. The chemical and physical characteristics of the ingredients vary considerably. These characteristics and the kiln temperatures combine to produce brick in a variety of colors and harnesses. In some geographical regions, individual pits yield clay or shale which, when ground and moistened, can be formed and baked into durable brick. In other regions, clay or shale from several pits must be mixed.

Standard U.S. bricks are 2¼×3¾ by 8 inches nominal size. They may have three core holes or 10 core holes. Modular US bricks are 2¼×3⅝×7⅝ inches nominal size. They usually have three core holes. English bricks are 3×4½×9 inches; Roman bricks are 1½×4×12 inches; and Norman bricks are 2¾×4×12 inches nominal size. Actual brick dimensions may be smaller, usually by an amount equal to a mortar joint width. Bricks can weigh from 100 to 150 pounds per cubic foot, depending on the ingredients and duration of firing. Fired brick is heavier than under-burned brick. The six surfaces of conventional brick are called cull, beds, side, end, and face.

Occasionally break is cut into varying shapes to fill in spaces at corners and other locations where a full break is not conducive to the desired wall shape.

Face brick is often of better quality and has better durability and appearance than building break. Because of this, face bricks are used in exposed wall faces. The most common face brick colors are various shades of brown, red, gray, yellow, and white.

Clinker brick is over burned in the kiln. Clinker bricks are usually rough, hard, durable, and sometimes irregular in shape.

Pressed brick is made by a dry-press process rather than by kiln firing. Pressed bricks have regular smooth faces, sharp edges, and perfectly square corners. Ordinarily, they are used like face brick.

Brick masonry units may be solid, hollow, or architectural terra cotta. All types can serve a structural function, a decorative function, or a combination of both. The various types of conventional brick differ in their formation and composition.

Building brick, also called common, hard, or kiln-run brick, is made from ordinary clay or shale and is fired in kilns. These bricks have no special shoring, markings, surface texture, or color. Because building bricks are generally used as the backing courses in either silent or cavity brick walls, the harder and more durable types are preferred—suited to walls or partitions in hospitals, dairies, laboratories and other structures requiring sanitary conditions and ease of cleaning.

Firebrick is made from a special type of clay. This clay is very pure and uniform and is able to withstand the high temperatures of fireplaces, boilers, and similar constructions. Fire bricks are generally huger than other structural bricks and are often hand molded.

Cored bricks can have 10 holes—two rows of five holes each-extending through their beds to reduce weight. Walls built from cored brick are not much different in strength than walls built from solid break. Also, both have about the same resistance to moisture penetration.

European brick has strength and durability about equal to US clay brick. This is particularly true of the English and Dutch types.

Sand-lime brick is made from a lean mixture of slaked lime and fine sand. Sand-lime bricks are molded under mechanical pressure and are hardened under steam pressure. These bricks are used extensively in Germany.

Brick is a popular facade material used in construction to increase a structure's aesthetic appeal and value. Many housing associations require a brick or a partial brick facade in order to improve the aesthetic value of a neighborhood. A brick front, however, isn't always an affordable upgrade because of cost, and most homeowners choose to build a brick front only if their budgets will permit.

Similarly, cinder bricks are used in landscape architecture to add depth to a yard. Cinder bricks are also used to construct outdoor patios, fences, pillars, and entrances. The advantages and improvements that brick offers to properties make any alternative that is similar in appearance an attractive one.

Conventional pavers can be understood as pre-cast concrete or stone slabs used as surface decking material. Pavers can also be understood as blocks of stone used in sidewalk or areaway paving. Still further, pavers can be understood as a brick-like piece of concrete commonly used as exterior flooring.

### BRIEF SUMMARY OF THE INVENTION

An embodiment is directed to an engineered brick having a plastic shell having a shape that resembles a conventional brick; and an aggregate layer embedded into the surface of the plastic shell.

An embodiment is directed to an engineered paver having a plastic shell having a shape that resembles a conventional paver; and an aggregate layer embedded into the surface of the plastic shell.

Another embodiment is directed to a method for manufacturing an engineered brick, the method having the steps of injection molding or extrusion molding a plastic shell having a shape that resembles a conventional brick; and embedding an aggregate layer into the plastic shell's outer surface.

Embodiments provide for an engineered brick that resembles a conventional brick, but the engineered brick is relatively lightweight and manufactured relatively inexpensively.

Engineered-brick embodiments will enjoy commercial success as evidenced by the current commercial successes of pergo flooring that resembles hardwood floors and the textured laminate that resembles granite countertops.

Engineered-brick embodiments provide for all of the aesthetic advantages that conventional brick provides. The advantages include improved aesthetic appearance of a facade (resulting in the improved value of a structure using the subject embodiments) and relatively reduced maintenance compared to the maintenance required with traditional aluminum siding. Also, the cost of the engineered-brick embodiments may be competitive with traditional aluminum siding.

Furthermore, using the subject embodiments provide the benefit of constructing structures with a light-weight material. Light-weight materials reduce the health risks, back strains, and injuries to masons. Another benefit of the reduced risks may result in reduced insurance and labor costs to the parties hiring the masons. The relatively light-weight engineered bricks will improve productivity at work sites because the light-weight embodiments make them easier and faster to work with compared to conventional brick. Improved productivity resulting from using the relatively light-weight engineered bricks may increase the profits for the builder and decrease the cost of building a home for the builder's client.

An additional benefit of the subject embodiments is that they may be used in any way that a conventional brick is utilized, e.g., on facades, in landscaping, and for fireplaces.

### BRIEF DESCRIPTION OF THE DRAWINGS

The invention may take physical form in certain parts and arrangement of parts, embodiments of which will be described in detail in this specification in illustrated in the accompanying drawings which former part hereof, and wherein:

FIG. 1 is a perspective view of a conventional brick having three core holes;

FIG. 2 is a perspective view of a conventional cinder brick;

FIG. 3 is a front view of a wall constructed with an engineered-brick embodiment, wherein the engineered-brick wall has an appearance similar to that of a wall constructed using conventional brick;

FIG. 4 is a perspective cross-sectional view of an injection-molded shell used in manufacturing an engineered brick; and

FIG. 5 is a perspective cross-sectional view of an engineered brick with its aggregate layer on the surface of the shell.

### DETAILED DESCRIPTION OF THE INVENTION

Certain terminology is used herein for convenience only and is not to be taken as a limitation on the subject embodiments. Relative language used herein is best understood with reference to the drawings, in which like numerals are used to identify like or similar items. Furthermore, in the figures, certain features may be shown somewhat schematic form.

Embodiments provide for the scope of the definition assigned to the term “brick” to be understood as being broad enough to include “paver.”

FIG. 1 illustrates a standard brick 100a having three core holes 112a.

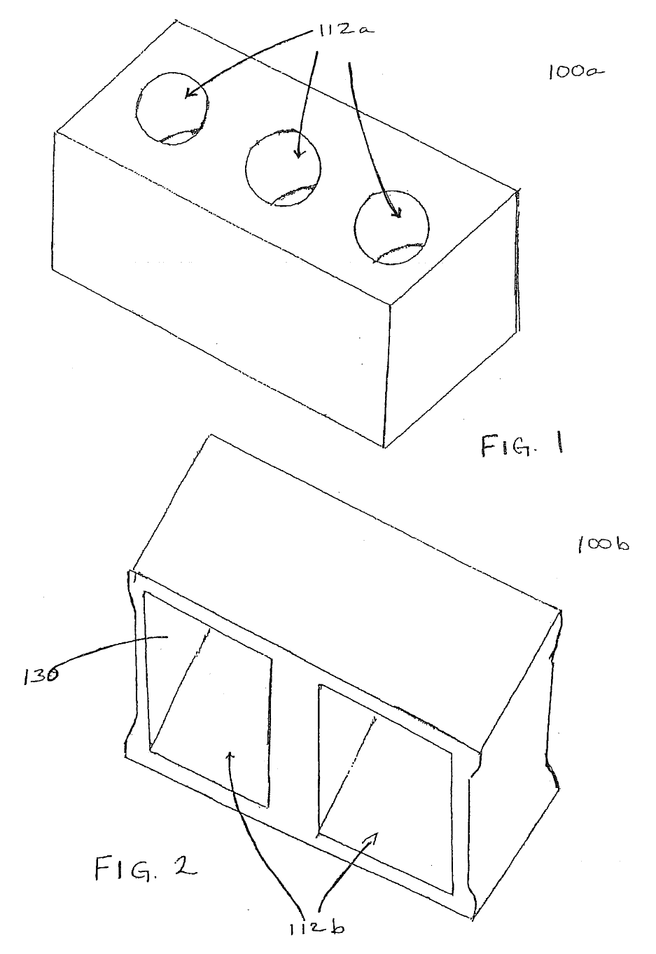

FIG. 2 illustrates a standard cinder brick 100b made from coal cinders and portland cement. Cinder brick 100b has i) a substantially rectangular face, side, and beds; ii) hollow square cores 112b; and iii) walls 130.

The subject embodiments are directed to engineered brick 10 having a polymeric shell 12 and aggregates embedded into the surface of the polymeric shell 12 resulting in aggregate layer 18. Aggregate layer 18 creates the aesthetic appearance of a conventional brick surface, and the polymeric shell 12 contributes to an overall lightweight engineered brick 10.

Engineered brick 10 has a polymeric shell 12 having a shape resembling any known conventional brick. Nonlimiting examples of useful shell 12 shapes include any conventional brick shape. Specific nonlimiting examples of useful shapes include standard US bricks with 0, 3, or 10 core holes; modular US bricks with 0 or 3 core holes; English bricks; Roman bricks; Norman bricks; and cinder bricks.

Engineered brick 10 can be manufactured using any known polymer or polymer composition. A person of ordinary skill in the art can select useful polymers or polymer compositions without having to exercise undue experimentation.

Embodiments provide for engineered brick 10 to be manufactured with ribs 16 formed on substantially hollow interior portion 14; ribs 16 increase the structural rigidity of engineered brick 10. The longitudinal direction of ribs 16 can be parallel or perpendicular to the longitudinal axis of interior portion 14. Alternatively, in an engineered-brick cinder-brick embodiment, ribs 16 can be parallel or perpendicular to the longitudinal axis of a square core. FIGS. 4 and 5 illustrate brick 10 embodiments having ribs 16 that are parallel to the longitudinal axis of interior portion 14.

Embodiments provide for manufacturing shell 12 using any useful method known to persons of ordinary skill in the art. Specific embodiments are directed to manufacturing shell 12 using conventional injection- or extrusion-molding processes. Persons of ordinary skill in the art will be able to select useful processing temperatures based upon the selected molding process as well as known useful temperatures for molding the subject polymer or polymer composition.

Embodiments provide for manufacturing shell 10 slightly smaller or slightly larger in overall dimensions than the dimensions of the conventional brick shape being copied.

The aggregates used to create aggregate layer 18, which covers the surface of shell 12, can be any conventionally known aggregate or material used in the manufacture of natural bricks or fascia stone products. Specific aggregate embodiments are directed to stone, brick powder, clay, lime, cement, silica, polymer beads, or combinations thereof.

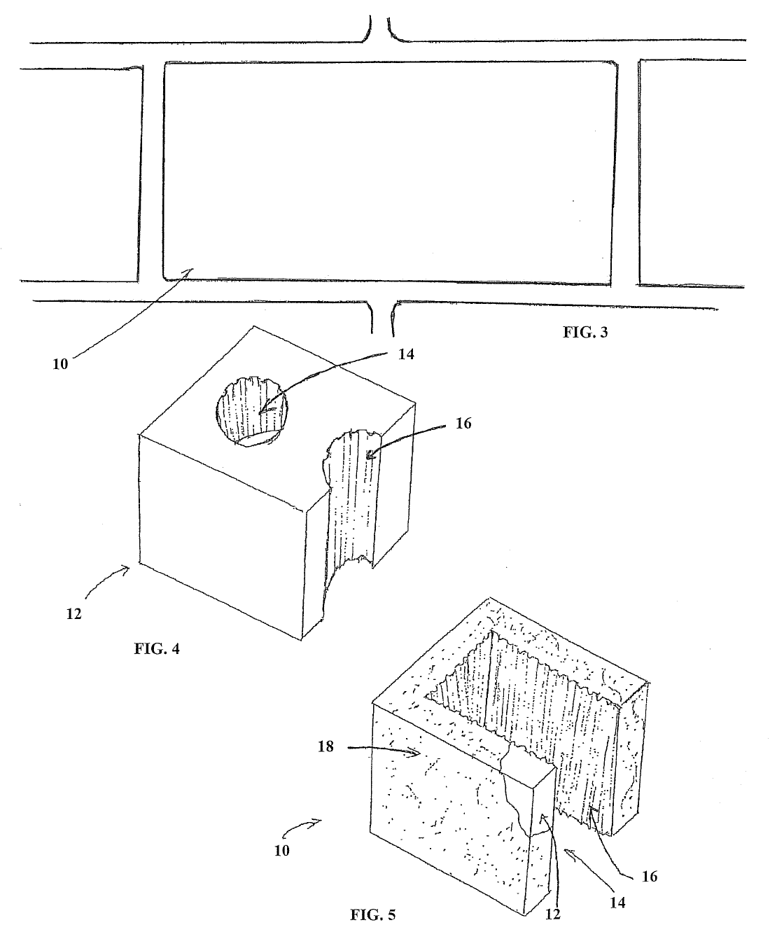

Aggregate layer 18 can cover any amount of shell 12's surface area. Embodiments provide for aggregate layer 18 covering substantially 100% or less than substantially 100% of shell 12's outer surface area. Persons of ordinary skill in the art can select the amount of shell 12's outer surface area to be covered by aggregate layer 18 based upon the intended end use of engineered brick 10 and the portion of engineered brick 10 that will be visually exposed in the anticipated end-use application. As a nonlimiting examples, and as illustrated in FIG. 3, aggregate layer 18 may selectively cover only the visible portions of engineered-brick surfaces that will be visible in a completed wall construction.

Embodiments provide for aggregate layer 18 being created by embedding a plurality of aggregates into shell 12's surface. This can be accomplished by sandblasting or tumbling shell 12 with a selected aggregate or combination of aggregates. FIG. 5 illustrates aggregate layer 18 embedded into shell 12's surface.

In order to facilitate embedding of aggregates into the surface of shell 12, an adhesive may be applied to the surface of shell 12 prior to embedding the aggregates. Any useful conventional adhesive may be employed. Useful adhesives and useful amounts of selected adhesives can be selected by persons of ordinary skill in the art without having to exercise undue experimentation.

In another embodiment, in order to facilitate embedding of aggregates into the surface of shell 12, the shell 12 surface is heated and thereby softened; the softened shell 12 surface prepares polymeric shell 12 to more readily accept embedding of aggregates. Temperatures used to soften the surface of polymeric shell 12 can be selected by persons of ordinary skill in the art based upon at least the known composition of shell 12, the composition's known melt temperatures, and the exposure duration of shell 12 to the heat source. In an embodiment, heating the surface of shell 12 can occur in one or more conditioning tunnels. Useful conditioning tunnels can employ any heat source to soften the surface of shell 12. A nonlimiting example of a useful heat source is an infrared heater. Other known methods for heating the outer surface of shell 12 can be employed.

Multiple conditioning tunnels can be used as a function of the surface-area concentration of aggregates that can be embedded into the surface of shell 12 as a result of a single pass through a conditioning tunnel. Persons of ordinary skill in the art will be able to select useful conditioning tunnel conditions as well as the number of passes through conditioning tunnels required to achieve the desired surface-area concentration of aggregates on the surface of shell 12.

Embodiments provide for sandblasting or tumbling shell 12 with aggregates after shell 12 has passed through a conditioning tunnel and thereby softened its outer surface.

What is claimed is:

1. An engineered brick comprising:
a plastic shell having a shape that resembles a conventional brick; and
an aggregate layer embedded into the surface of the plastic shell.

2. The engineered brick of claim 1, wherein the aggregate is selected from the group consisting of stone, brick powder, clay, lime, cement, silica, polymer beads, and combinations thereof.

3. The engineered brick of claim 1, wherein the aggregate is stone.

4. The engineered brick of claim 1, wherein the aggregate is brick powder.

5. The engineered brick of claim 1, wherein the aggregate is clay.

6. The engineered brick of claim 1, wherein the aggregate is lime.

7. The engineered brick of claim 1, wherein the aggregate is cement.

8. The engineered brick of claim 1, wherein the aggregate is silica.

9. The engineered brick of claim 1, wherein the aggregate is polymer beads.

10. The engineered brick of claim 1, wherein the aggregate covers the entire outer surface of the engineered brick.

11. The engineered brick of claim 1 further comprising an adhesive layer that covers the outer surface of the plastic shell and into which the aggregate embeds.

12. The engineered brick of claim 1 further comprising an interior portion that is substantially hollow.

13. The engineered brick of claim 12, wherein structural ribs are formed on the surface of the interior portion.

14. The engineered brick of claim 1 further comprising plastic shell dimensions of about 2¼×3¾×8 inches.

15. The engineered brick of claim 1 further comprising plastic shell dimensions of about 8×8×16 inches.

16. A method for manufacturing an engineered brick, the method comprising the steps:
injection molding or extrusion molding a plastic shell having a shape that resembles a conventional brick; and
embedding an aggregate layer into the plastic shell's outer surface.

17. The method of claim 16, further comprising the step:
applying an adhesive layer to the outer surface of the plastic shell prior to embedding an aggregate layer into the plastic shell's outer surface.

18. The method of claim 16, further comprising the step:
softening the outer surface of the shell prior to embedding an aggregate layer into the plastic shell's outer surface.

19. The method of claim 16, wherein the aggregate layer is embedded into the plastic shell's outer surface by sandblasting the aggregate into the surface of the plastic shell, tumbling the shell in a controlled environment with the aggregate, or a combination thereof.

20. An engineered paver comprising:
a plastic shell having a shape that resembles a conventional paver; and
an aggregate layer embedded into the surface of the plastic shell.
